(19) United States
(12) Patent Application Publication
(10) Pub. No.: US 2022/0185445 A1
(43) Pub. Date: Jun. 16, 2022

(54) WING DETACHMENT ASSEMBLY AND AERIAL VEHICLE

(71) Applicant: AUTEL ROBOTICS CO., LTD., Shenzhen (CN)

(72) Inventor: Yuanyuan DU, Shenzhen (CN)

(21) Appl. No.: 17/653,525

(22) Filed: Mar. 4, 2022

Related U.S. Application Data
(63) Continuation of application No. PCT/CN2020/123359, filed on Oct. 23, 2020.

(30) Foreign Application Priority Data
Sep. 5, 2019 (CN) 201921474701.3

(51) Int. Cl. B64C 1/26

(52) U.S. Cl. CPC B64C 1/26

(57) ABSTRACT

Embodiments of the present invention discloses a wing detachment assembly and an aerial vehicle. The wing detachment assembly includes a first connecting portion and a second connecting portion. The first connecting portion includes a fixing base, a press-fitting member and a fastening member, one of the fixing base and the second connecting portion being fixed on a wing and the other being fixed on a vehicle body. A mounting groove is provided on the second connecting portion, a notch of the mounting groove being provided far away from the first connecting portion. The press-fitting member is rotatably connected to the fixing base, the fastening member is rotatably connected to the press-fitting member, an end of the fastening member is fastened in the mounting groove.

### CROSS REFERENCE

The present application is a continuation of International Application No. PCT/CN2020/123359, filed on Oct. 23, 2020, which claims priority to Chinese patent application No. 2019214747013, filed on Sep. 5, 2019, which is incorporated herein by reference in its entirety.

### TECHNICAL FIELD

The utility model relates to the field of aerial vehicle technologies, and in particular, to a wing detachment assembly and an aerial vehicle.

### BACKGROUND

An aerial vehicle may provide people with entertainment or may perform a task for people. For example, the aerial vehicle may be used as an important tool for high-altitude photography. Generally, the aerial vehicle includes a wing and a vehicle body. The aerial vehicle may occupy a relatively large space due to such a relatively long wing. Accordingly, an aerial vehicle having a detachable wing has emerged. However, an existing solution for detaching and mounting the wing of the aerial vehicle is relatively inconvenient and requires a dedicated detachment tool.

Therefore, how to provide a solution for conveniently detaching and mounting the wing of the aerial vehicle has become a technical requirement in the related art.

### SUMMARY

The utility model is mainly intended to provide a wing detachment assembly and an aerial vehicle, to resolve an existing technical problem that a solution for detaching and mounting a wing of an aerial vehicle is relatively inconvenient.

According to a first aspect, the utility model provides a wing detachment assembly, configured to detachably connect a wing of an aerial vehicle to a vehicle body of the aerial vehicle. The wing detachment assembly includes a first connecting portion and a second connecting portion. The first connecting portion includes a fixing base, a press-fitting member and a fastening member, one of the fixing base and the second connecting portion being fixed on the wing and the other being fixed on the vehicle body.

A mounting groove is provided on the second connecting portion, a notch of the mounting groove being provided far away from the first connecting portion.

The press-fitting member is rotatably connected to the fixing base, the fastening member is rotatably connected to the press-fitting member, an end of the fastening member is fastened in the mounting groove and the press-fitting member is configured to be press-fitted to drive the fastening member to be far away from the notch of the mounting groove, to enable the fastening member to be fastened in the mounting groove.

Preferably, the fastening member includes a fastening connection rod and a fastening body disposed on one end of the fastening connection rod, an other end of the fastening connection rod being rotatably connected to the press-fitting member.

Preferably, the fastening body is spherical or cylindrical.

Preferably, a middle portion of the press-fitting member is rotatably connected to the fastening member.

Preferably, the press-fitting member includes a press-fitting connection rod and a press-fitting handle, an end of the press-fitting connection rod being rotatably connected to the fixing base, an other end of the press-fitting connection rod being fixedly connected to the press-fitting handle and the press-fitting connection rod and the press-fitting handle being located on different straight lines.

Preferably, the mounting groove includes a groove bottom and a groove wall, the groove bottom and the groove wall being connected to form an arc surface.

Preferably, the wing detachment assembly further includes a buckling member configured to fix the press-fitting member, the buckling member fixing the press-fitting member when the fastening member is fastened in the mounting groove.

Preferably, the first connecting portion further includes a first connecting plate, the first connecting plate being fixedly connected to the fixing base.

When the fixing base is fixed on the vehicle body, the first connecting plate is fixed on an inner wall of a housing of the vehicle body and the fixing base passes through the housing of the vehicle body to be rotatably connected to the press-fitting member; or

when the fixing base is fixed on the wing, the first connecting plate is fixed on an inner wall of a housing of the wing and the fixing base passes through the housing of the wing to be rotatably connected to the press-fitting member.

Preferably, the second connecting portion includes a connecting base and a second connecting plate, the mounting groove being provided on the connecting base, the second connecting plate being fixedly connected to the connecting base and the second connecting plate being configured to be fixed on an inner wall of a housing of the vehicle body or the wing.

When the second connecting portion is fixed on the vehicle body, the connecting base passes through the housing of the vehicle body to enable the mounting groove to be exposed from the housing of the vehicle body; or

when the second connecting portion is fixed on the wing, the connecting base passes through the housing of the wing to enable the mounting groove to be exposed from the housing of the wing.

According to a second aspect, the utility model further provides an aerial vehicle. The aerial vehicle includes a vehicle body, a wing and the foregoing wing detachment assembly. The wing is detachably connected to the vehicle body by using the wing detachment assembly.

Compared with existing technologies, in the utility model, a mounting groove is provided on a second connecting portion and a notch of the mounting groove is provided away from the first connecting portion. The first connecting portion includes a fixing base, a press-fitting member and a fastening member. The fixing base is configured to be fixed on the vehicle body or the wing. The press-fitting member is rotatably connected to the fixing base. The fastening member is rotatably connected to the press-fitting member. An end of the fastening member is configured to be fastened in the mounting groove. The press-fitting member is configured to be press-fitted to drive the fastening member to be far away from the notch of the mounting groove. In this way, the fastening member is fastened in the mounting groove. The wing can be quickly mounted on the vehicle body and the wing can also be quickly detached from the vehicle body without using a dedicated detachment tool, which may be easy to manually detach and mount.

### BRIEF DESCRIPTION OF THE DRAWINGS

FIG. 1 is a schematic structural diagram of a wing detachment assembly of the utility model.

FIG. 2 is a schematic structural diagram of a first connecting portion of the utility model.

FIG. 3 is a schematic three-dimensional structural diagram of a first connecting plate of the utility model.

FIG. 4 is a schematic structural diagram of a press-fitting member of the utility model.

FIG. 5 is a schematic structural diagram of a fastening member of the utility model.

FIG. 6 is a schematic structural diagram of a buckling member of the utility model.

FIG. 7 is a schematic structural diagram of a second connecting portion of the utility model.

FIG. 8 is a schematic structural diagram of an aerial vehicle of the utility model.

FIG. 9 is an enlarged schematic structural diagram of A in FIG. 8.

### DETAILED DESCRIPTION

To make the objectives, technical solutions and advantages of the utility model clearer and more comprehensible, the following further describes the utility model in detail with reference to the accompanying drawings and embodiments. It is to be understood that specific embodiments described herein are merely used to describe the utility model, but are not intended to limit the utility model. All other embodiments obtained by a person of ordinary skill in the art based on the embodiments of the utility model without creative efforts shall fall within the protection scope of the utility model.

The terms such as “first”, “second”, “third” and “fourth” (if any) in this specification, claims and the accompanying drawings of the present application are used for distinguishing between similar objects and not necessarily used for describing any particular order or sequence. It is to be understood that the data used in such a way is interchangeable in proper cases, so that the embodiments described herein can be implemented in other orders other than the order illustrated or described herein. Moreover, the terms “include”, “contain” and any other variation thereof are intended to cover the non-exclusive inclusion. For example, a process, method, system, product or device that includes a series of steps or units is not necessarily limited to such steps or units, but may include other steps or units not expressly listed or inherent to such a process, method, product or device.

In addition, technical solutions of various embodiments may be combined with each other, but need to be based on the technical solutions that can be implemented by a person of ordinary skill in the art. When a combination of the technical solutions is contradictory or cannot be implemented, it should be considered that such a combination of the technical solutions does not exist and does not fall within the protection scope of the utility model.

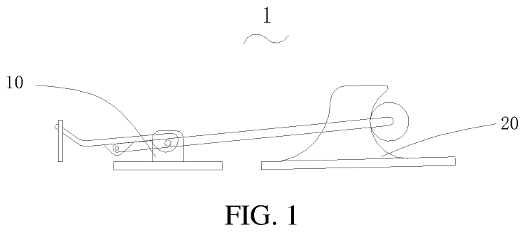

Referring to FIG. 1, the utility model provides a wing detachment assembly 1 configured to detachably connect a wing of an aerial vehicle to a vehicle body of the aerial vehicle. The wing detachment assembly 1 includes a first connecting portion 10 and a second connecting portion 20. The first connecting portion 10 and the second connecting portion 20 can be quickly detached and connected. One of the first connecting portion 10 and the second connecting portion 20 is fixed to the wing and the other is fixed to the vehicle body. In this embodiment, the description is made by using an example in which the first connecting portion 10 is fixed on the vehicle body and the second connecting portion 20 is fixed on the wing.

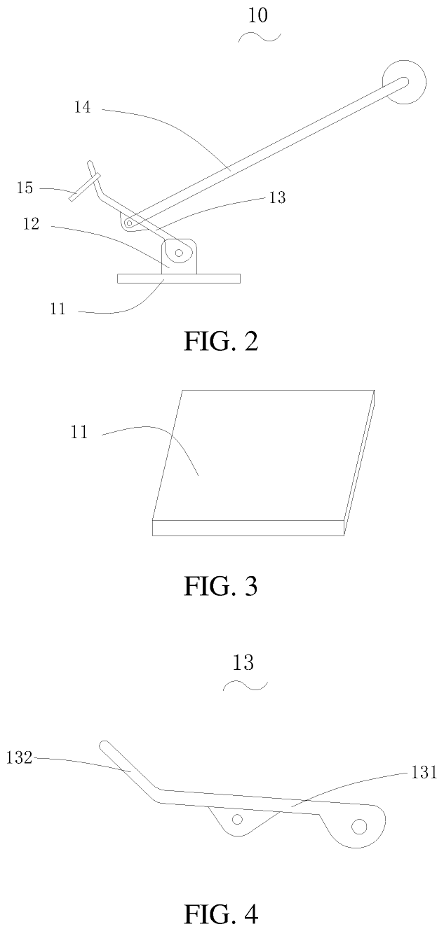

Referring to FIG. 2, the first connecting portion 10 includes a first connecting plate 11, a fixing base 12, a press-fitting member 13, a fastening member 14 and a buckling member 15. The first connecting plate 11 is fixedly connected to the fixing base 12. The press-fitting member 13 is rotatably connected to the fixing base 12. The fastening member 14 is rotatably connected to the press-fitting member 13. The first connecting plate 11 is configured to be fixed on the vehicle body. An end of the fastening member 14 is configured to be fastened to the second connecting portion 20. The press-fitting member 13 is press-fitted under the action of an external force to drive the fastening member 14 to be far away from the second connecting portion 20 as a whole. In this way, the fastening member 14 is fixed to the second connecting portion 20. The buckling member 15 is configured to be fixed to the press-fitting member 13. In other words, the press-fitting member 13 is fixed to the vehicle body, so that the connection between the first connecting portion 10 and the second connecting portion 20 is more stable. It is to be understood that the configuration of the buckling member 15 may be omitted.

Referring to FIG. 3, a shape of the first connecting plate 11 is not limited. For example, the first connecting plate 11 may be circular or quadrilateral. In this embodiment, the first connecting plate 11 is fixed on an inner wall of a housing of the vehicle body. The fixing base 12 passes through the housing of the vehicle body to be rotatably connected to the press-fitting member 13. The first connecting plate 11 is firmly fixed on the inner wall of the housing, which is not prone to falling. The first connecting plate 11 may be adhered to the inner wall of the housing of the vehicle body. An area of the first connecting plate 11 is set according to requirements. When the area of the first connecting plate 11 is large, a pressure on the housing of the vehicle body is relatively small. Therefore, the housing of the vehicle body is not necessarily configured to be excessively thick. It is to be understood that, the first connecting plate 11 may alternatively be fixed on an outer wall of the housing of the vehicle body or embedded in the housing of the vehicle body.

A specific structure for rotatably connecting the fixing base 12 and the press-fitting member 13 is not limited. For example, the connection may be implemented by using a hinge structure, a rotating shaft structure or a pin structure. The fixing base 12 and the first connecting plate 11 may be integrally formed. It is to be understood that a structure for rotatably connecting other two components is also not limited. It is to be understood that, the configuration of the first connecting plate 11 may be omitted, so that the fixing base 12 is fixed on the vehicle body.

Referring to FIG. 2 and FIG. 4 together, an end of the press-fitting member 13 is rotatably connected to the fixing base 12 and a middle portion of the press-fitting member 13 is rotatably connected to the fastening member 14. A distance between the middle portion and the end of the press-fitting member 13 is greater than one third of a length of the press-fitting member 13. A distance between the middle portion and an other end of the press-fitting member 13 is less than two-thirds of length of the press-fitting member 13. The press-fitting member 13 includes a press-fitting connection rod 131 and a press-fitting handle 132. An end of the press-fitting connection rod 131 is rotatably connected to the fixing base 12. An other end of the press-fitting connection rod 131 is fixedly connected to the press-fitting handle 132. The press-fitting connection rod 131 and the press-fitting handle 132 are located on different straight lines. The press-fitting handle 132 helps a user apply a force to the press-fitting member 13 during detachment and mounting of the wing. The press-fitting connection rod 131 and the press-fitting handle 132 may be integrally formed.

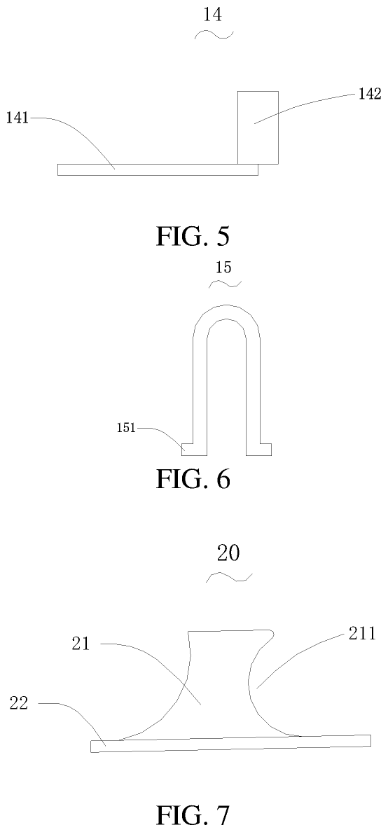

Referring to FIG. 2 and FIG. 5 together, the fastening member 14 includes a fastening connection rod 141 and a fastening body 142 disposed on one end of the fastening connection rod 141. An other end of the fastening connection rod 141 is rotatably connected to the press-fitting member 13. The fastening connection rod 141 and the fastening body 142 are located on different planes, so that the fastening body 142 can be fastened to the second connecting portion 20.

The fastening connection rod 141 is rod-shaped. A cross-sectional area of the fastening connection rod 141 is not limited. For example, the cross-sectional area may be circular or quadrilateral.

The fastening body 142 is spherical or cylindrical, which can be better in contact with the second connecting portion 20. When the fastening body 142 is cylindrical, an end portion of the cylinder is connected to a side wall of the fastening connection rod 141.

Referring to FIG. 6, the buckling member 15 is U-shaped. A middle portion of the buckling member 15 is configured to fasten the press-fitting member 13. Two ends of the buckling member 15 are configured to be fixed on the vehicle body. For example, a hole or a groove may be provided on the vehicle body for fixing. As an option, protrusions 151 are respectively disposed on outer sides of the two ends of the U-shaped buckling member 15 to be engaged with the vehicle body.

Referring to FIG. 2 and FIG. 7 together, the second connecting portion 20 includes a connecting base 21 and a second connecting plate 22. The connecting base 21 is fixedly connected to the second connecting plate 22. The second connecting plate 22 is configured to be fixed on the wing. The connecting base 21 is configured for fixing of the fastening member 14.

A shape of the second connecting plate 22 is not limited. For example, the second connecting plate 22 may be circular or quadrilateral. In this embodiment, the second connecting plate 22 is fixed on an inner wall of a housing of the wing. The connecting base 21 passes through the housing of the vehicle body to be connected to the fastening member 14. The second connecting plate 22 is firmly fixed on the inner wall of the housing of the wing, which is not prone to falling. The second connecting plate 22 may be adhered to the inner wall of the housing of the wing. An area of the second connecting plate 22 is set according to requirements. When the area of the second connecting plate 22 is large, a pressure on the housing of the wing is relatively small. Therefore, the housing of the wing is not necessarily configured to be excessively thick. It is to be understood that, the second connecting plate 22 may alternatively be fixed on an outer wall of the housing of the wing or embedded in the housing of the wing.

A mounting groove 211 is provided on the connecting base 21. A notch of the mounting groove 211 is provided away from the first connecting portion 10. The press-fitting member 13 is press-fitted to drive the fastening member 14 to be far away from the notch of the mounting groove 211 as a whole. In this way, the fastening body 142 of the fastening member 14 is fastened in the mounting groove 211. In other word, the fastening body 142 is fixed in the mounting groove 211. It is to be understood that, the configuration of the second connecting plate 22 may be omitted, so that the connecting base 21 is fixed on the wing.

The mounting groove 211 includes a groove bottom and a groove wall. The groove bottom and the groove wall are connected to form an arc surface. Therefore, the fastening body 142 may be easier to be fixed in the mounting groove 211. It is to be understood that a shape of the mounting groove 211 is not limited in the present application. For example, the mounting groove 211 may alternatively be a V-shaped groove.

During use, the first connecting plate 11 of the first connecting portion 10 is fixed on the inner wall of the housing of the vehicle body and the second connecting plate 22 of the second connecting portion 20 is fixed on the inner wall of the housing of the wing. The press-fitting member 13 is rotated and the fastening body 142 of the fastening member 14 is disposed in the mounting groove 211. Then, the press-fitting member 13 is rotated again, so that the fastening member 14 is far away from the notch of the mounting groove 211 as a whole and the fastening body 142 is pressed on the groove bottom of the mounting groove 211. The buckling member 15 fixes the press-fitting member 13 on the vehicle body when the fastening member 14 is fastened in the mounting groove 211. In this way, the wing is mounted on the vehicle body. It is to be understood that, when one aerial vehicle includes two wings, two wing detachment assemblies are required for quickly detaching each wing. It is to be understood that the wing may be detached by inversely performing the foregoing operation.

It is to be understood that, when fixing base 12 of the first connecting portion 10 is fixed on the wing and the second connecting portion 20 is fixed on the vehicle body, the first connecting plate 11 is fixed on the inner wall of the housing of the wing, the fixing base 12 passes through the housing of the wing to be rotatably connected to the press-fitting member 13 and the connecting base 21 of the second connecting portion 20 passes through the housing of the vehicle body to enable the mounting groove 211 to be exposed from the housing of the vehicle body.

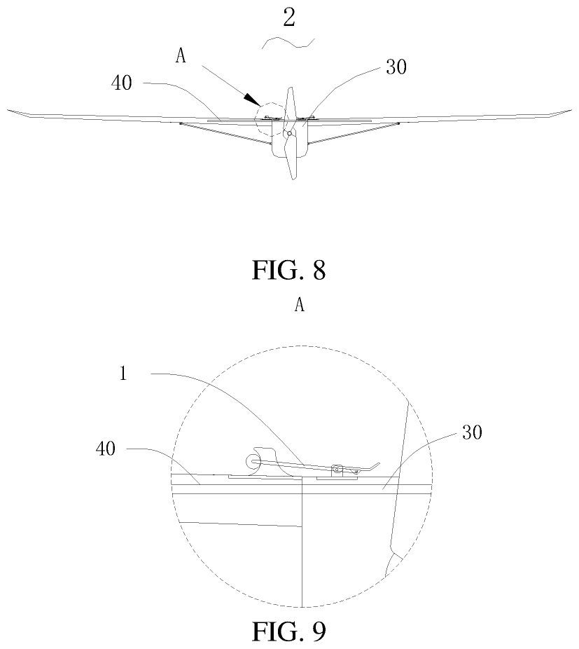

Referring to FIG. 8 and FIG. 9 together, the utility model further provides an aerial vehicle 2. The aerial vehicle 2 includes a vehicle body 30, a wing 40 and the foregoing wing detachment assembly 1. The wing 40 is detachably connected to the vehicle body 30 by using the wing detachment assembly 1. The aerial vehicle 2 may be a flight device such as an unmanned aerial vehicle.

Compared with existing technologies, in the utility model, a mounting groove is provided on a second connecting portion, a notch of the mounting groove being provided far away from the first connecting portion. The first connecting portion includes a fixing base, a press-fitting member and a fastening member. The fixing base is configured to be fixed on the vehicle body or the wing. The press-fitting member is rotatably connected to the fixing base. The fastening member is rotatably connected to the press-fitting member. An end of the fastening member is configured to be fastened in the mounting groove. The press-fitting member is configured to be press-fitted to drive the fastening member to be far away from the notch of the mounting groove. In this way, the fastening member is fastened in the mounting groove. The wing can be quickly mounted on the vehicle body and the wing can also be quickly detached from the vehicle body without using a dedicated detachment tool, which is easy to manually detach.

It is to be noted that, the sequence numbers of the foregoing embodiments of the utility model are merely for description purpose but are not intended to indicate the preference of the embodiments. In addition, terms “comprise”, “include” or any variation thereof in this specification are intended to cover non-exclusive inclusion. Therefore, a process, a device, an article or a method including a series of elements not only include such elements, but also includes other elements not listed explicitly or includes intrinsic elements for the process, the device, the article, or the method. Unless otherwise specified, an element limited by “include a/an . . . ” does not exclude other same elements existing in the process, the device, the article, or the method including the element.

The foregoing descriptions are merely exemplary embodiments of the utility model but are not intended to limit the patent scope of the utility model. Any equivalent modifications made to the structures or processes based on the content of the specification and the accompanying drawings of the utility model for direct or indirect use in other relevant technical fields shall fall within the patent protection scope of the utility model.

What is claimed is:

1. A wing detachment assembly, configured to detachably connect a wing of an aerial vehicle to a vehicle body of the aerial vehicle, wherein the wing detachment assembly comprises a first connecting portion and a second connecting portion, the first connecting portion comprising a fixing base, a press-fitting member and a fastening member, one of the fixing base and the second connecting portion being fixed on the wing and the other being fixed on the vehicle body;
a mounting groove is provided on the second connecting portion, a notch of the mounting groove being provided far away from the first connecting portion; and
the press-fitting member is rotatably connected to the fixing base, the fastening member is rotatably connected to the press-fitting member, an end of the fastening member is fastened in the mounting groove and the press-fitting member is configured to be press-fitted to drive the fastening member to be far away from the notch of the mounting groove, to enable the fastening member to be fastened in the mounting groove.

2. The wing detachment assembly according to claim 1, wherein the fastening member comprises a fastening connection rod and a fastening body disposed on one end of the fastening connection rod, an other end of the fastening connection rod being rotatably connected to the press-fitting member.

3. The wing detachment assembly according to claim 2, wherein the fastening body is spherical or cylindrical.

4. The wing detachment assembly according to claim 1, wherein a middle portion of the press-fitting member is rotatably connected to the fastening member.

5. The wing detachment assembly according to claim 1, wherein the press-fitting member comprises a press-fitting connection rod and a press-fitting handle, an end of the press-fitting connection rod being rotatably connected to the fixing base, an other end of the press-fitting connection rod being fixedly connected to the press-fitting handle and the press-fitting connection rod and the press-fitting handle being located on different straight lines.

6. The wing detachment assembly according to claim 1, wherein the mounting groove comprises a groove bottom and a groove wall, the groove bottom and the groove wall being connected to form an arc surface.

7. The wing detachment assembly according to claim 1, wherein the wing detachment assembly further comprises a buckling member configured to fix the press-fitting member, the buckling member fixing the press-fitting member when the fastening member is fastened in the mounting groove.

8. The wing detachment assembly according to claim 1, wherein the first connecting portion further comprises a first connecting plate, the first connecting plate being fixedly connected to the fixing base;
when the fixing base is fixed on the vehicle body, the first connecting plate is fixed on an inner wall of a housing of the vehicle body and the fixing base passes through the housing of the vehicle body to be rotatably connected to the press-fitting member; or
when the fixing base is fixed on the wing, the first connecting plate is fixed on an inner wall of a housing of the wing and the fixing base passes through the housing of the wing to be rotatably connected to the press-fitting member.

9. The wing detachment assembly according to claim 1, wherein the second connecting portion comprises a connecting base and a second connecting plate, the mounting groove being provided on the connecting base, the second connecting plate being fixedly connected to the connecting base and the second connecting plate being configured to be fixed on an inner wall of a housing of the vehicle body or the wing;
when the second connecting portion is fixed on the vehicle body, the connecting base passes through the housing of the vehicle body to enable the mounting groove to be exposed from the housing of the vehicle body; or
when the second connecting portion is fixed on the wing, the connecting base passes through the housing of the wing to enable the mounting groove to be exposed from the housing of the wing.

10. An aerial vehicle, comprising:
a vehicle body;
a wing; and
a wing detachment assembly, wherein the wing detachment assembly comprises a first connecting portion and a second connecting portion, the first connecting portion comprising a fixing base, a press-fitting member and a fastening member, one of the fixing base and the second connecting portion being fixed on the wing and the other being fixed on the vehicle body;
a mounting groove is provided on the second connecting portion, a notch of the mounting groove being provided far away from the first connecting portion;
the press-fitting member is rotatably connected to the fixing base, the fastening member is rotatably connected to the press-fitting member, an end of the fastening member is fastened in the mounting groove and the press-fitting member is configured to be press-fitted to drive the fastening member to be far away from the notch of the mounting groove, to enable the fastening member to be fastened in the mounting groove; and
the wing is detachably connected to the vehicle body by using the wing detachment assembly.

11. The aerial vehicle according to claim 10, wherein the fastening member comprises a fastening connection rod and a fastening body disposed on one end of the fastening connection rod, an other end of the fastening connection rod being rotatably connected to the press-fitting member.

12. The aerial vehicle according to claim 11, wherein the fastening body is spherical or cylindrical.

13. The aerial vehicle according to claim 10, wherein a middle portion of the press-fitting member is rotatably connected to the fastening member.

14. The aerial vehicle according to claim 10, wherein the press-fitting member comprises a press-fitting connection rod and a press-fitting handle, an end of the press-fitting connection rod being rotatably connected to the fixing base, an other end of the press-fitting connection rod being fixedly connected to the press-fitting handle and the press-fitting connection rod and the press-fitting handle being located on different straight lines.

15. The aerial vehicle according to claim 10, wherein the mounting groove comprises a groove bottom and a groove wall, the groove bottom and the groove wall being connected to form an arc surface.

16. The aerial vehicle according to claim 10, wherein the wing detachment assembly further comprises a buckling member configured to fix the press-fitting member, the buckling member fixing the press-fitting member when the fastening member is fastened in the mounting groove.

17. The aerial vehicle according to claim 10, wherein the first connecting portion further comprises a first connecting plate, the first connecting plate being fixedly connected to the fixing base;
when the fixing base is fixed on the vehicle body, the first connecting plate is fixed on an inner wall of a housing of the vehicle body and the fixing base passes through the housing of the vehicle body to be rotatably connected to the press-fitting member; or
when the fixing base is fixed on the wing, the first connecting plate is fixed on an inner wall of a housing of the wing and the fixing base passes through the housing of the wing to be rotatably connected to the press-fitting member.

18. The aerial vehicle according to claim 10, wherein the second connecting portion comprises a connecting base and a second connecting plate, the mounting groove being provided on the connecting base, the second connecting plate being fixedly connected to the connecting base and the second connecting plate being configured to be fixed on an inner wall of a housing of the vehicle body or the wing;
when the second connecting portion is fixed on the vehicle body, the connecting base passes through the housing of the vehicle body to enable the mounting groove to be exposed from the housing of the vehicle body; or
when the second connecting portion is fixed on the wing, the connecting base passes through the housing of the wing to enable the mounting groove to be exposed from the housing of the wing.
